(19) United States
(12) Patent Application Publication
(10) Pub. No.: US 2026/0352438 A1
(43) Pub. Date: Nov. 5, 2026

(54) MAPPING OF CIPHERTEXT AUTOMORPHISMS ON HARDWARE WITH BUTTERFLY NETWORKS

(71) Applicant: International Business Machines Corporation, Armonk, NY (US)

(72) Inventors: Subhankar Pal, White Plains, NY (US); Nir Drucker, Zichron Yaakov (IL); Aporva Amarnath, White Plains, NY (US); Yongmo Park, White Plains, NY (US)

(73) Assignee: International Business Machines Corporation, Armonk, NY (US)

(21) Appl. No.: 19/198,075

(22) Filed: May 4, 2025

(51) Int. Cl. H04L 9/00; H04L 9/06; H04L 9/08

(52) U.S. Cl. CPC H04L 9/008; H04L 9/00; H04L 9/06; H04L 9/0618; H04L 9/08; H04L 9/0819

(57) ABSTRACT

An embodiment includes constructing a Homomorphic Encryption system comprising a set of processing cells configured in a butterfly network. The embodiment includes generating, by executing a specially purposed configuration instruction within a configuration component of the Homomorphic Encryption system, a switch rule for each processing cell of the set of processing cells. The embodiment also includes executing the switch rule by a processing component of the Homomorphic Encryption system on the set of processing cells where the Homomorphic Encryption system computes an automorphism operation by traversing the butterfly network according to a number of input elements of the automorphism operation.

### BACKGROUND

The present invention relates generally to encryption. More particularly, the present invention relates to a method, system, and computer program for Mapping of Ciphertext Automorphisms on Hardware with Butterfly Networks.

With the increasing concern about data privacy and integrity, privacy-preserving computing has been adopted in many real-world applications, such as cloud computing, machine learning, and data storage. Machine learning applications without privacy-preserving computation techniques require access to raw data, which can expose sensitive information like healthcare records or financial transactions. When data is stored or processed in the cloud, the need for encryption becomes even more critical.

Data encryption including encrypted machine learning enables collaboration between parties who do not want to share their raw data but still want to leverage each other's data. Machine learning encryption, or privacy-preserving machine learning (PPML), involves enabling machine learning models to compute directly on encrypted data, returning encrypted results, thus preserving data privacy. This is achieved through techniques like homomorphic encryption (HE) which allows computation on encrypted data without decryption. Entities can enrich their models by leveraging the data of others, without ever compromising the confidentiality of the information shared.

### SUMMARY

The illustrative embodiments provide for Mapping of Ciphertext Automorphisms on Hardware with Butterfly Networks. An embodiment includes constructing a Homomorphic Encryption system comprising a set of processing cells configured in a butterfly network. The embodiment includes generating, by executing a specially purposed configuration instruction within a configuration component of the Homomorphic Encryption system, a switch rule for each processing cell of the set of processing cells. The embodiment also includes executing the switch rule by a processing component of the Homomorphic Encryption system on the set of processing cells where the Homomorphic Encryption system computes an automorphism operation by traversing the butterfly network according to a number of input elements of the automorphism operation.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of an implementation of a Homomorphic Encryption (HE) system in accordance with an illustrative embodiment;

FIG. 3 depicts a diagram of an automorphism operation in accordance with an illustrative embodiment;

FIG. 4 depicts a diagram of existing approaches using Benes ((2 log N−1) stages) or Omega (log N stages) networks to execute an automorphism operation in accordance with an illustrative embodiment;

FIG. 5 depicts a diagram of an automorphism operation using a Gentleman-Sande (GS) network enhancing existing hardware that performs Fast Fourier Transform (FFT)/Number Theoretic Transform (NTT) computations in accordance with an illustrative embodiment;

FIG. 6A depicts an algorithm to determine the number of required stages in a butterfly network in accordance with an illustrative embodiment;

FIG. 6B depicts a diagram of a Gentleman-Sande (GS) network enhancing existing hardware that performs fast Fourier Transform (FFT)/Number Theoretic Transform (NTT) computations to perform an automorphism operation in accordance with an illustrative embodiment;

FIG. 7 depicts a flow chart of performing an automorphism operation using a Gentleman-Sande network enhancing existing hardware that performs Fast Fourier Transform (FFT)/Number Theoretic Transform (NTT) computations to in accordance with an illustrative embodiment;

FIG. 8 depicts a system diagram of a Gentleman-Sande network enhancing existing hardware that performs Fast Fourier Transform (FFT)/Number Theoretic Transform (NTT) computations to perform an automorphism operation in accordance with an illustrative embodiment;

FIG. 9A depicts graphs of a Gentleman-Sande network enhancing existing hardware that performs Fast Fourier Transform (FFT)/Number Theoretic Transform (NTT) computations compared to Omega and Benes networks to perform an automorphism operation in accordance with an illustrative embodiment; and

FIG. 9B depicts a chart comparing the number of stages traversed by the rotation amount of a Gentleman-Sande network enhancing existing hardware that performs Fast Fourier Transform (FFT)/Number Theoretic Transform (NTT) computations versus an Omega network to perform an automorphism operation in accordance with an illustrative embodiment.

### DETAILED DESCRIPTION

Among all the privacy-preserving technologies, Homomorphic Encryption (HE) emerges as one of the most important and promising technologies and has been adopted in various applications. Specifically, HE allows performing arbitrary operations directly over the encrypted data without decryption, making it appealing for privacy-preserving computation. This allows organizations to leverage machine learning capabilities for sensitive applications without compromising data privacy.

Although promising, one fundamental drawback of HE is its inefficiency. Compared to plaintext computation, HE-enabled computation is orders of magnitude slower, which restricts its deployment in many performance-critical systems. Existing approaches use Benes ((2 log N−1) stages) or Omega (log N stages) networks to perform automorphism using dedicated hardware. A Field Programmable Gate Array (FPGA) is first used to build circuits to efficiently execute NTT, inverse NTT (iNTT), and key-switching in HE schemes. These FPGA-based accelerators are affordable but suffer from intrinsic disadvantages of FPGA itself: limited programmable resources and low working frequency. Then, to overcome these disadvantages, people have sought out expensive Application-Specific Integrated Circuit (ASIC) technologies to build high-performance HE accelerators.

Existing approaches use Benes ((2 log N−1) stages) or Omega (log N stages) networks to perform automorphism using dedicated and/or special purpose hardware. Currently, there is no way to ensure a computation of automorphisms, that is necessary for HE, using a reduced butterfly network hardware and without the need for special purpose hardware. There are no existing butterfly network hardware that will eliminate area and power overhead associated with automorphism units in an HE hardware accelerator.

The present disclosure addresses the deficiencies described above by providing a process (as well as a system, method, machine-readable medium, etc.) that constructs a butterfly network with set of processing cells, a switch rule for each processing cell of the set of processing cells and recent advances in HE to compute an automorphism operation of a polynomial by traversing the butterfly network.

The illustrative embodiments provide for Mapping of Ciphertext Automorphisms on Hardware with Butterfly Networks. As used herein, the term “butterfly network” may refer to a basic computational unit in hardware, representing a butterfly structure that uses multipliers and/or gates to perform a specific multiplication and addition/subtraction operation. In some uses, a butterfly network may also be implemented in software. The term “automorphism” as used herein may refer to a specific operation used to rotate or shift the coefficients within a packed ciphertext, effectively permuting the slots (or elements) within the ciphertext. Consider a vector [a,b,c,d,e]. In (plaintext) hardware these operations are as follows: Rotation left by 2: [c,d,e,a,b], Rotation right by 1: [e,a,b,c,d], Shift right by 2: [0,0,a,b,c], Shift left by 2: [c,d,e,0,0]. In contrast, a “shuffle” and “permutations” are different since these operations may result in vectors such as: [a,a,a,a,a], [e,c,d,a,b] [b,b,a,e,d] which cannot be achieved through simple shifts and rotations. When considering a ciphertext we can consider an object that encrypts for example a vector. An automorphism on a ciphertext (which can be constructed from polynomials) is an operation that rotates the underlying encrypted vector (slots). However, it is not a rotation of the coefficients of the ciphertext itself. Instead, it performs a “shuffle” or a “permutation” of the coefficients of the ciphertext polynomials.

As used herein, the term “machine learning model” may refer to any computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Machine learning models can learn through training, where data with known outcomes is inputted into the computer model, outputs regarding the data are compared to the known outcomes, and/or the weights of the computer model are autonomously adjusted based on the comparison to replicate the known outcomes.

Illustrative embodiments include constructing a Homomorphic Encryption system comprising a set of processing cells configured in a butterfly network.

As used herein, the term “Homomorphic Encryption” may refer to computations comprising arbitrary operations directly over the encrypted data without decryption. As used herein, the term “Fast Fourier Transform” may refer to an algorithm that computes the discrete Fourier transform (DFT) of a sequence, or its inverse (IDFT) including but not limited to variations such as number theoretic transform (NTT) or similar, and the term “Fast Fourier Transform circuit” as used herein may refer to a circuit to compute FFT including but not limited to butterfly networks such as Gentleman-Sande Network.

Illustrative embodiments include generating, by executing a specially purposed configuration instruction within a configuration component of the Homomorphic Encryption system, a switch rule for each processing cell of the set of processing cells. In some embodiments, executing the configuration instruction on a polynomial modulus a degree and a rotation amount outputs the switch rule comprising a set of configuration bits for each switch in the butterfly network.

Illustrative embodiments include executing the switch rule by a processing component of the Homomorphic Encryption system on the set of processing cells wherein the Homomorphic Encryption system computes an automorphism operation by traversing the butterfly network according to a number of input elements of the automorphism operation. In some embodiments, a number of stages of the butterfly network of the Homomorphic Encryption system is determined based on a coefficient index modulus a number of input elements.

As used herein, the term “traverse” may refer to routing of the computations through the butterfly network with or without requiring all of the stages of the network.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

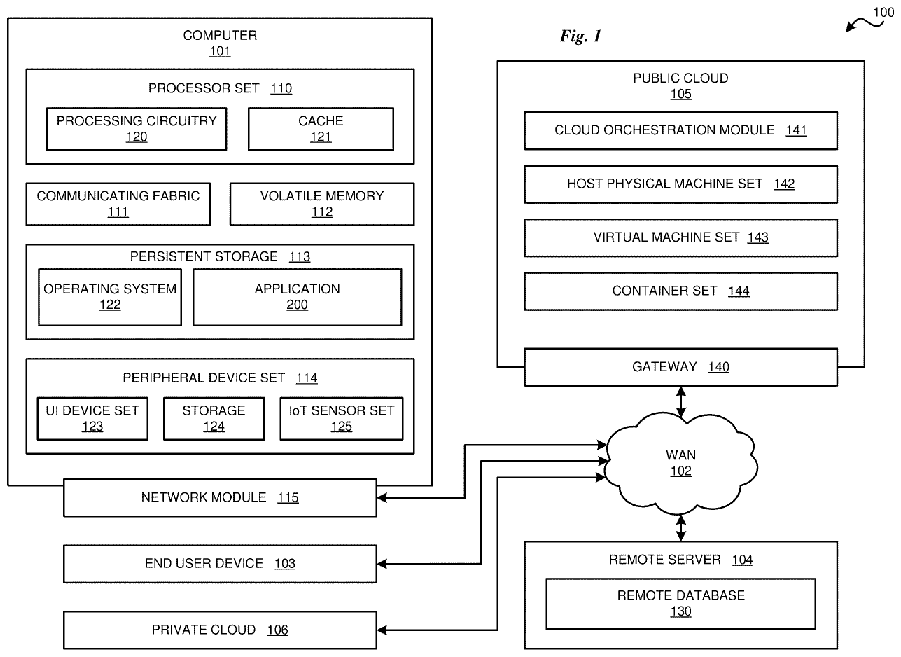

With reference to FIG. 1, this figure depicts a block diagram of a computing environment 100. Data center environment 100 contains an example of an environment for the execution of at least some of the computer code involved in performing the inventive methods, such as an Application 200 that provides Mapping of Ciphertext Automorphisms on Hardware with Butterfly Networks. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

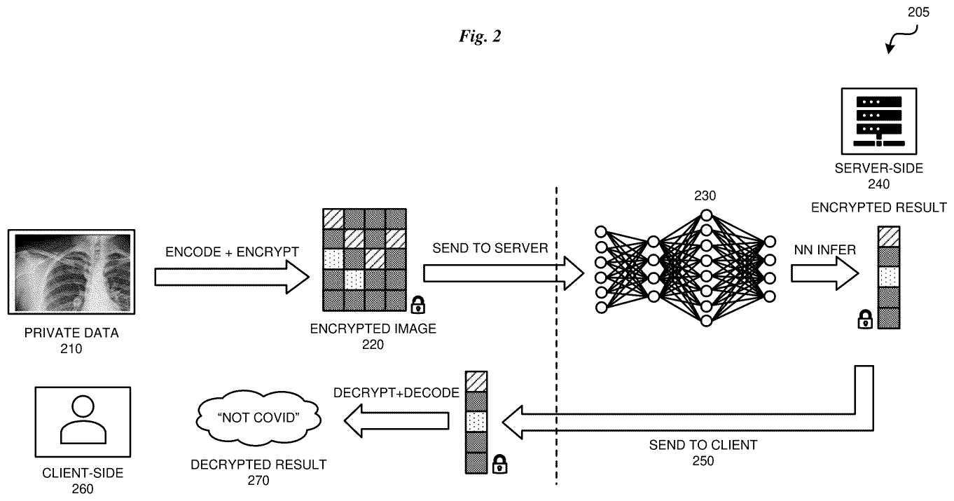

FIG. 2 depicts a diagram of an implementation of a Homomorphic Encryption (HE) system in accordance with an illustrative embodiment. In a particular embodiment, the components of diagram 205 show aspects of the Application 200 of FIG. 1.

In the illustrated embodiment, an implementation depicts HE which is a privacy-preserving solution for computation on encrypted data without decryption. For example, privacy-preserving neural network (NN) inference on encrypted data. Private data in plaintext 210 may be encoded and encrypted with a public key 220 and transmitted from a client side to a server. The server 230 executes HE on the encrypted data to generate an encrypted result 240. The encrypted result is transmitted to a client 250. On the client side 260, the result is then decrypted to result in a decrypted result 270. Adding ciphertexts gives an encryption of the sum of the underlying plaintexts. Multiplying two ciphertexts give an encryption of the product of the underlying plaintexts. In an example use case, in a healthcare setting, detection of medical conditions such as Covid of the decrypted result 270 may require the gathering of sensitive data. Under HIPAA, using this highly identifiable information could pose a breach of privacy. Homomorphic encryption could preserve patient privacy while allowing health care evaluation to take place.

The goal of encoding is to convert cleartext messages into polynomials for the subsequent homomorphic operations. Many ciphertexts and keys in the algorithms are in the form of polynomials. In these cases, the underlying operations of HE schemes are polynomial operations. Polynomial operations, including polynomial additions and multiplications, are the basic building blocks of the HE algorithms. To implement the operations, there are two common representations of a polynomial: coefficient representation and point-value representation. The polynomials in HE are naturally generated in the coefficient representation.

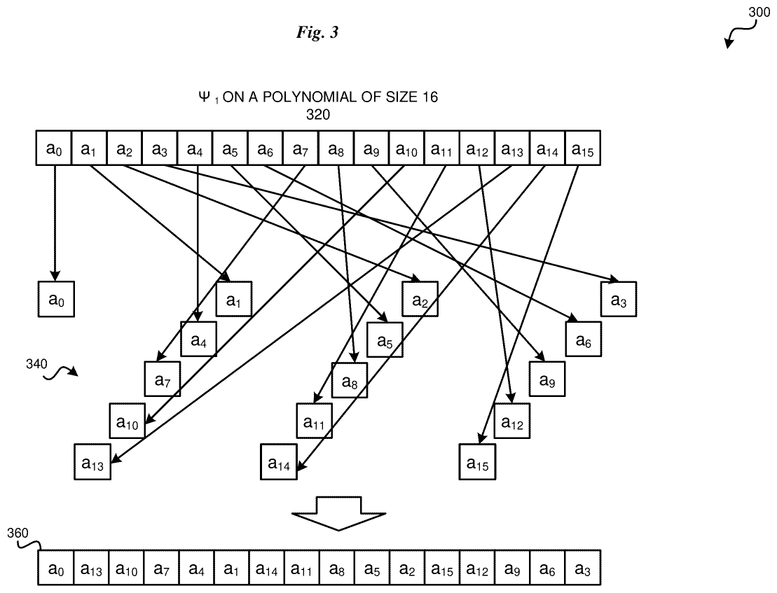

FIG. 3 depicts a diagram of an automorphism operation in accordance with an illustrative embodiment. In a particular embodiment, the components of diagram 300 show aspects of the Application 200 of FIG. 1.

In the illustrated embodiment, a HE scheme that is gaining traction today for privacy-preserving machine learning is Cheon-Kim-Kim-Song (CKKS) algorithm, due to its ability to support fixed-point arithmetic.

HE schemes, such as CKKS, operate on ciphertexts in a homomorphic single instruction multiple data (SIMD) fashion. This means that a single ciphertext encrypts a fixed-size vector, and the homomorphic operations on the ciphertext are performed slot-wise on the elements of the plaintext vector. To utilize the SIMD feature, we need to pack and encrypt more than one input element in every ciphertext. When treating the encrypted elements as an encrypted vector it is possible to apply a transformation called automorphism on the ciphertext to cyclically rotate the encrypted vector (under encryption).

Typically, in CPU/GPU architectures, CKKS automorphisms are done by shuffling elements following a mapping, Vr:
ψᵣ: i->i*5^{r} mod N (i=0, 1, . . . . N−1)

Here, r is the rotation amount in the range [1, N/2−1] and N is the polynomial modulus degree.

Given a vector of 8 elements 320, a polynomial of 16 degrees and 16 coefficients for the polynomial encrypts the 8 elements. A rotation r of the vector by 1, rotates the plaintext vector by 1. Rotate may be “rotate left” and “rotate right”. For instance, when r is positive, we consider a left rotation and when it is negative we consider a right rotation. Using the automorphism equation from above, set the value r to be one. As depicted by 340, for the first position α₀, if r is 1 so this equals 5 and then 0*5 is just zero, so it stays in the location, as further depicted by 360. For the second position α₁, goes to the fifth location because 1*5 is five and then the element α₂ is 2*5 goes to the 10th location. For α₄, modulus N, where N=16, so 4*5 which is 20 modulus 16 so remains in the same position as shown by 360.

In an embodiment, an automorphism step is a step in one or more steps performed for a rotation. For example, for CKKS the Rotation operation by k of a ciphertext c=(c0,c1)∈R\hat{ }2_{Q_1} involves four steps where the automorphism step is the second step, for instance, Decompose: Convert c1 into a vector d based on a decomposition base b. Permute: Apply the automorphism psi to each component of c. MultSum: Compute (c0′, c1′)=<d, rtk_k>∈R\hat{ }2_{Q_I*P}. ModDown: Reduce the modulus of (c0′, c1′) to return it to R\hat{ }2_{Q_I}.

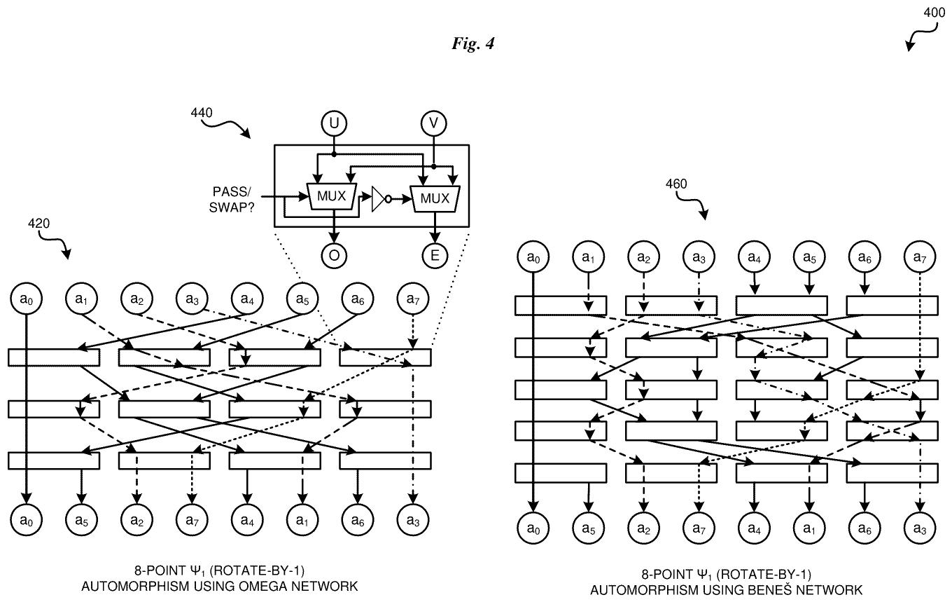

FIG. 4 depicts a diagram of existing approaches using use Benes ((2 log N−1) stages) or Omega (log N stages) networks to execute an automorphism operation in accordance with an illustrative embodiment.

In the illustrated embodiment, an 8-point Ψ₁ (psi rotate by 1) automorphism using a known Omega Network is depicted at 420. Each cell 440 comprises multiplexors that determine whether to pass or swap based the automorphism. The depiction at 460 shows n 8-point (i.e. N=8), Ψ₁ (psi rotate-by-1) automorphism using a known Benes Network. The networks use dedicated hardware where the number of stages is determined by (2 log N−1) stages for Benes Network, which uses two back-to-back forward and inverse butterfly networks, and log N stages for the Omega network. In both cases, there is no reduction in the number of stages based on the rotation step.

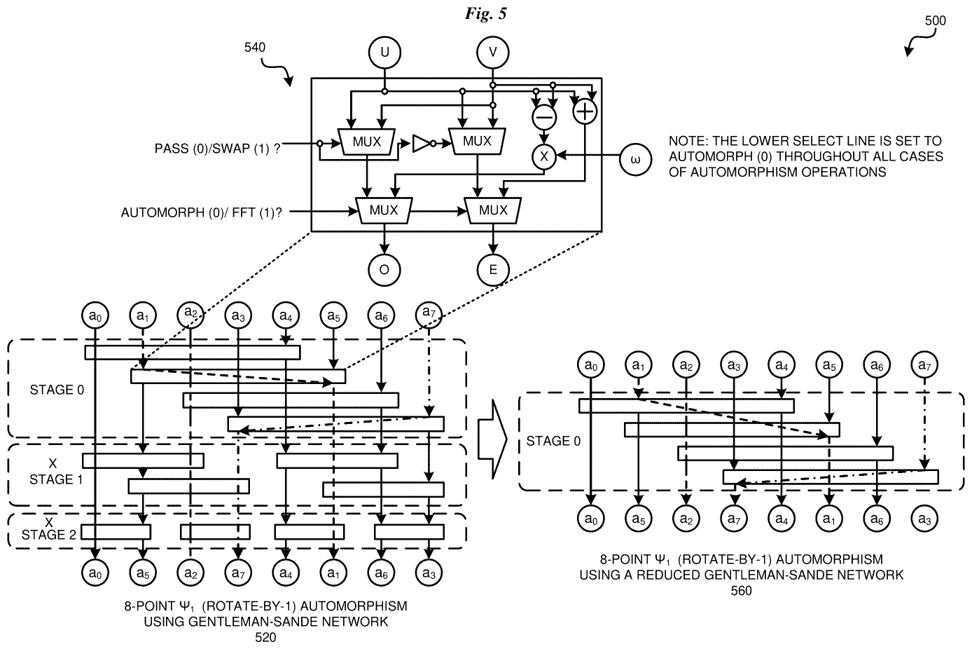

FIG. 5 depicts a diagram of an automorphism operation using a Gentleman-Sande (GS) network enhancing existing hardware that performs Fast Fourier Transform (FFT)/Number Theoretic Transform (NTT) computations in accordance with an illustrative embodiment. In a particular embodiment, the components of diagram 500 show aspects of the Application 200 of FIG. 1.

In the illustrated embodiment, the HE system 520 comprises a baseline butterfly network or set of interconnected processing cells in hardware, grouped into stages such as what may be typically used to accelerate fast Fourier transform (FFT) or number theoretic transform (NTT) in cryptographic applications, augmented with lightweight hardware switches to perform HE automorphism, additionally. In this example, there are eight inputs, two inputs for each cell (U, V), so four cells per stage are provided. Each cell 540 comprises of a FFT and/or NTT elements for subtraction, addition and multiplication with some constant. In embodiments, the cell further comprises four multiplexors. The two multiplexors in the first row will process 0 to pass through or 1 to swap the values U and V. As an additional example, in response to 0, the two multiplexors in the second row of switches to pass through the cell since automorphism of a polynomial is computed involving shuffling. In response to 1, a subtraction, addition and/or multiplication is performed to output O and E.

All values through Stage 1 and 2 are all pass through with no swapping. And using this network allows the reduction in the number of stages as depicted by 560.

In embodiments, generating, by within a configuration component within the Homomorphic Encryption system executes a configuration instruction to output a switch rule for each of the set of processing cells. For example, an example special purpose code to compute the switch rule is:

```
  def compute_switch_rule(N, r):
    assert 1 <= r <= N/2-1
    logN = ceil(log2(N))
    num_stages_reqd = 0
```

gates = zeros((logN, N/2)) [symbol] Initialize 2D zero

```
  array of shape (logN, N/2)
    for src_index in 0...N-1:
```

dst_index = (src_index * modular_exp(5, r, N)) % N [symbol] modular_exp(b, r, N)

computes b^{r} mod N

```
        path = [ ] [symbol]    contains tuples of (stage_id, coefficient_id)
        shortest_path(path, 0, N, src_index, dst_index) [symbol]      path is updated in-place
```

num_stages_reqd = max(num_stages_reqd, len(path))

```
        calc_gate_switches(gates, path, logN, r) [symbol]    gates is updated in-place
  def shortest_path(path, stage_id, logN, src_index, dst_index): [symbol]     path is updated in-
```

```
  place
      if stage_id == logN:
        return
    if dst index == src_index:
        path = [(stage_id, dst_index)] + path
      return
```

```
      paired_index = src\hat{ }(1<<(logN-1-stage_id)) [symbol]     calculate the index that
  goes to the same gate as src_index in GS
      shortest_path(path, stage_id+1, logN, src_index, dst_index); [symbol]     recursive call to
  shortest_path( )
    if len(path) > 0:
        path = [(stage_id, src_index)] + path
        return
    shortest_path(path, stage_id+1, logN, paired_index, dst_index); [symbol]     recursive call to
  shortest_path( )
      if len(path) > 0:
  path = [(stage_id, src_index)] + path
  return
  def calc_gate_switches(gates, path, logN, r): [symbol]     gates is updated in-place
```

for i, stage_id, coeff_id in enumerate(path):

```
        rev_stage_id = logN-1-stage_id
        bfly_id =
  (coeff_id%(1<<rev_stage_id))+((coeff_id>>(rev_stage_id+1))<<rev_stage_id)
        if (i < len(path)-1) {
          next_stage_coeff_id = path[i+1][1]
          if next_stage_coeff_id == coeff id:
            gates[stage_id][bfly_id] = 0
          else:
            gates[stage_id][bfly_id] = 1
Or alternatively, the following Python code to generate the switch rule.
  # Compute the offsets of the output elements from the input positions
  def compute_cyclic_offsets(target_locations, N):
    return [((target_locations[i]-i) % N) for i in range(len(target_locations))]
  # For a given butterfly output compute which elements should move.
  def find_moves(offsets, bo):
    return [i for i in range(bo) if (offsets[i] & bo) != 0]
  # For a given butterfly output Apply the moves computed above by replacing elements
  in butterfly offset (bo) from each other.
  def apply_moves(offsets, moves, bo, N):
    for 1 in range(0, N, 2*bo):
        for m in moves:
          offsets[l + m] = (offsets[l + m] − bo) % N
          offsets[l + m + bo] = (offsets[l + m + bo] + bo) % N
  # Run an iterative application of applying moves for different butterfly offset (BO)
  values.
  def print_moves(N, r):
    target_locations = compute_target_locations(r, N)
    offsets = compute_cyclic_offsets(target_locations, N)
    for i in range(0, int(log(N,2))):
        moves = find_moves(offsets, 2\hat{ }i)
        print(“Changed elements:”, moves)
        apply_moves(offsets, moves, bo, N)
```

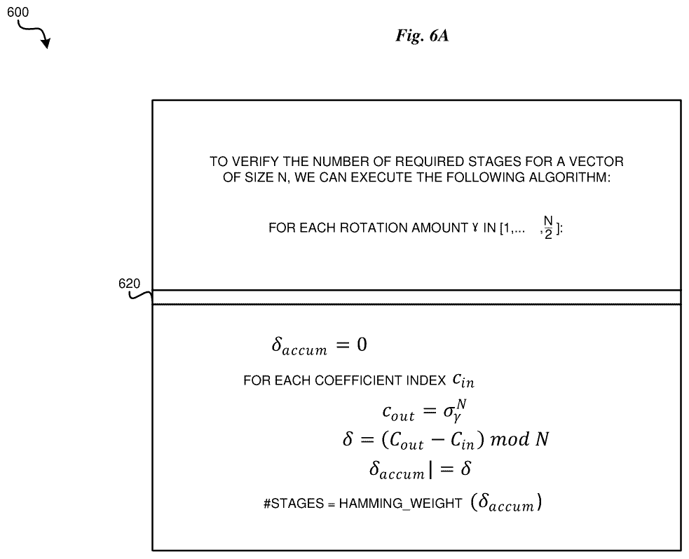

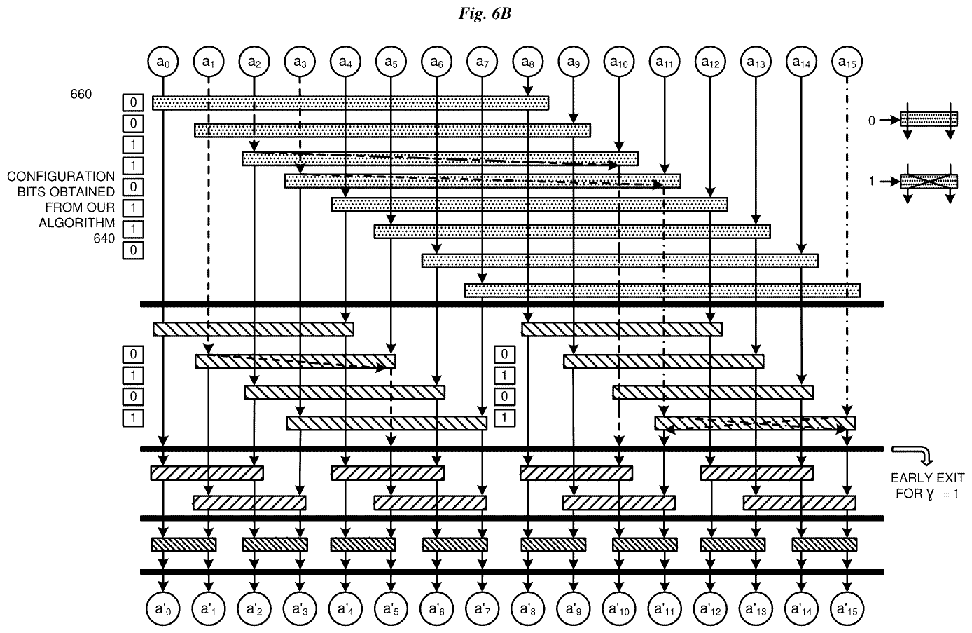

FIG. 6A depicts an algorithm to determine the number of required stages in a butterfly network in accordance with an illustrative embodiment. In a particular embodiment, the components of diagram 600 show aspects of the Application 200 of FIG. 1.

In the illustrated embodiment, an algorithm 620 is depicted to determine the number of required stages in a butterfly network for a ciphertext polynomial of element count N. In such examples, to determine the number of required stages is based on a coefficient index modulus the number of input elements.

FIG. 6B depicts a diagram of a Gentleman-Sande (GS) network enhancing existing hardware that performs fast Fourier Transform (FFT)/Number Theoretic Transform (NTT) computations to perform an automorphism operation in accordance with an illustrative embodiment. In a particular embodiment, the components of diagram 660 show aspects of the Application 200 of FIG. 1.

In the illustrated embodiment, executing a specially purposed configuration instruction within a configuration component of the Homomorphic Encryption system outputs a switch rule for each of the set of processing cells. For example, a switch rule is generated by executing a configuration instruction within a configuration component using the algorithms described above. In some examples, the switch rule may comprise of configuration bits 640 of zeros or ones for each processing cell or switch to either pass or compute a FFT operation. In such examples, the switch rule is executed by a processing component that includes but is not limited to a Field-programmable Gate Array (FPGA) and/or Application-Specific Integrated Circuit (ASIC), or similar comprising of multiplexors that in turn may be made up of AND and/or OR gates.

As depicted, while the network has log N stages in many cases, not all of these stages are required and given an input r we can early exit the network, reducing power and latency. For example, consider the case N=16 and r=1, where N is the count of input elements and r is the rotation, then the original network appears as depicted by 660. Thus, in embodiments, executing the switch rule computes the automorphism operation of a rotation on the polynomial of N elements using less than log N stages of the butterfly network.

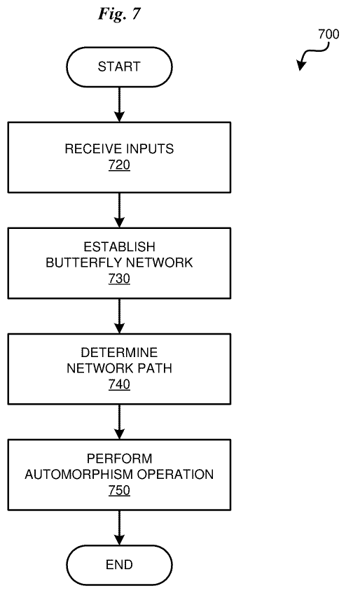

FIG. 7 depicts a flow chart of performing an automorphism operation using a Gentleman-Sande network enhancing existing hardware that performs fast Fourier Transform (FFT)/Number Theoretic Transform (NTT) computations to in accordance with an illustrative embodiment. In a particular embodiment, the components of diagram 700 show aspects of the Application 200 of FIG. 1.

In the illustrated embodiment, a HE system receives an input of ciphertext polynomial of N elements at step 720. For instance, HE is an encryption scheme that allows performing arbitrary computation over ciphertexts without decrypting them. HE evaluations include multiplications, additions, subtractions, and rotations.

At step 730, a butterfly network of the HE system is established/constructed comprising a set of processing cells configured in a butterfly network. In embodiments, the number of stages of the butterfly network of the Homomorphic Encryption system is determined based on a coefficient index modulus the number of input elements.

At step 740, the HE system determines a network path through the butterfly network. For example, a configuration component of the Homomorphic Encryption system executes a configuration instruction, as described above, to output a switch rule or mapping for each of the set of processing cells. The switch rule is executed by a processing component of the Homomorphic Encryption system on the set of processing cells wherein the Homomorphic Encryption system performs an automorphism operation of a polynomial at step 750 via a network path determined by the switch rule. In another example, steps 730 and 740 can be done “offline”, i.e., as a pre-processing of an HE circuit. In an example, a switch rule for an automorphism operation comprising rotations by 5, 13, and 27 may be determined in advance, stored in computer storage, and loaded on demand, and not during the HE computation itself.

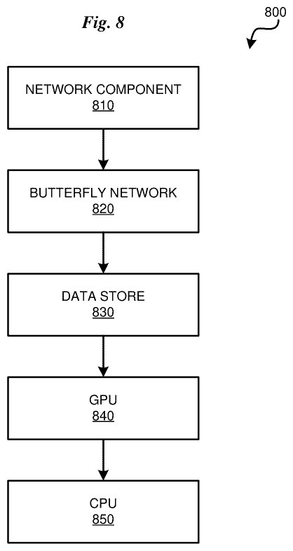

FIG. 8 depicts a system diagram of a Gentleman-Sande network enhancing existing hardware that performs fast Fourier Transform (FFT)/Number Theoretic Transform (NTT) computations to perform an automorphism operation in accordance with an illustrative embodiment. In a particular embodiment, the components of diagram 800 show aspects of the Application 200 of FIG. 1.

In the illustrated embodiment, the Homomorphic Encryption system comprises a network component 810, a butterfly network 820, a data store 830, a general processing unit (GPU) 840, and a central processing unit 850. For example, the network component 810 may comprise a network adaptor, a socket, a graphics card, one or more routers, switches, hubs, and/or other network connectivity devices. The network component may transmit and/or receive data via network links such as data may be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

The Homomorphic Encryption system may comprise a butterfly network 820 of a Gentleman-Sande network enhancing existing hardware that performs fast Fourier Transform (FFT)/Number Theoretic Transform (NTT) computations. The butterfly network may comprise of processing cells including but is not limited to a Field-programmable Gate Array (FPGA) and/or Application-Specific Integrated Circuit (ASIC), or similar comprising of multiplexors that in turn may be made up of AND and/or OR gates. Further examples include but are not limited to digital signal processing (DSP) cores, a reduced instruction set computer (RISC)-V cores with instruction set architecture (ISA) extensions extended with custom instructions to support FFT operations, and/or multipliers, adders, and first in first out (FIFO) memories. The FFT component may also comprise Address Generation Unit (AGU) controls the generation of addresses for reading and writing the memory contents to and from the Butterfly Processing Unit (BFU). The AGU also generates signals that control writes to memory as well as which memory bank is read.

A physical data storage device is the underlying technology behind a data store 830. The data store may comprise a data store interface that receives a provision instruction, its execution causing the data store to provision resources such as a start node queue, an end node queue, files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

GPU 840 due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

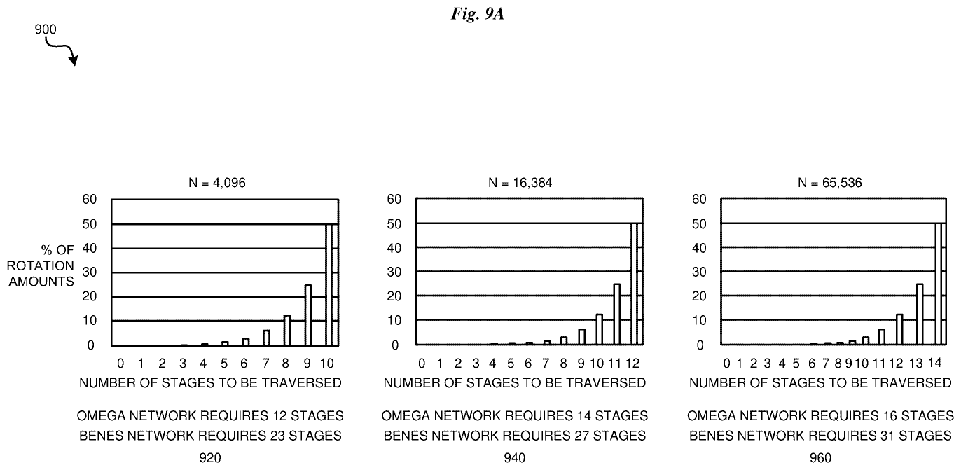

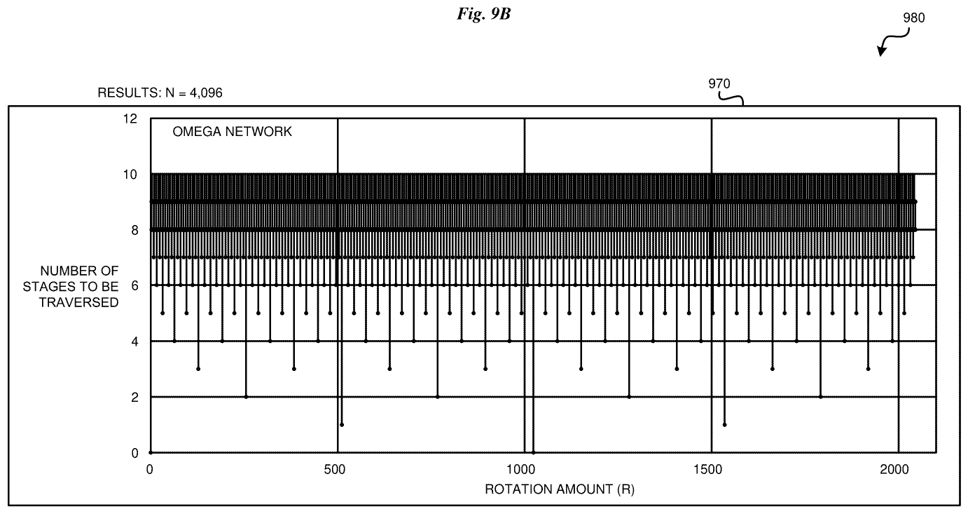

FIG. 9A depicts graphs of a Gentleman-Sande network enhancing existing hardware that performs fast Fourier Transform (FFT)/Number Theoretic Transform (NTT) computations compared to Omega and Benes networks to perform an automorphism operation in accordance with an illustrative embodiment. In a particular embodiment, the components of diagram 900 show aspects of the Application 200 of FIG. 1.

In the illustrated embodiment, graphs 920, 940 and 960 are plotted with x-axis of number of stages traversed to perform an automorphism operation versus y-axis of percentage of rotation amounts. Graph 920 depicts for N=4096, in 50% of the computations, the improved GS network as described herein traverses 10 stages as opposed to Omega network requires 12 stages and a Beneš network requires 23 stages. Graph 940 depicts for N=16,384, in 50% of the computations, the improved GS network as described herein traverses 12 stages as opposed to Omega network requiring 14 stages and a Beneš network requires 27 stages. Graph 960 depicts for N=65,536, in 50% of the computations, the improved GS network as described herein traverses 14 stages as opposed to Omega network requires 16 stages and a Beneš network requires 31 stages.

FIG. 9B depicts a chart comparing the number of stages traversed by the rotation amount of a Gentleman-Sande network enhancing existing hardware that performs fast Fourier Transform (FFT)/Number Theoretic Transform (NTT) computations versus an Omega network to perform an automorphism operation in accordance with an illustrative embodiment.

In the illustrated embodiment, the x-axis of the chart 980 is the rotation r and the y-axis the number of stages traversed to compute automorphism on a polynomial based on this r. For example, if the rotation r is 512, a power of 2, the number of stages traversed by the GS network with enhancements as described herein is 1 or 2. In contrast, the number of stages in the Omega network is 12 as shown by the baseline 970. In another example, if the rotation ris not a power of 2, the GS network will traverse 8 to 10 stages, as opposed to 12 stages traversed by the Omega network.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
constructing a Homomorphic Encryption system comprising a set of processing cells configured in a butterfly network;
generating, by executing a specially purposed configuration instruction within a configuration component of the Homomorphic Encryption system, a switch rule for each processing cell of the set of processing cells; and
executing the switch rule by a processing component of the Homomorphic Encryption system on the set of processing cells wherein the Homomorphic Encryption system computes an automorphism operation by traversing the butterfly network according to a number of input elements of the automorphism operation.

2. The computer-implemented method of claim 1, wherein executing the configuration instruction comprising a polynomial modulus a degree and a rotation amount outputs the switch rule comprising a set of configuration bits for each processing cell in the butterfly network.

3. The computer-implemented method of claim 1, wherein a number of stages of the butterfly network of the Homomorphic Encryption system is determined based on a coefficient index modulus a number of input elements of the polynomial.

4. The computer-implemented method of claim 1, wherein the set of processing cells is grouped into stages wherein executing the switch rule computes the automorphism operation of a rotation on a polynomial of N elements using less than log N stages of the butterfly network.

5. The computer-implemented method of claim 1, wherein each processing cell of the set of processing cells comprises at least a set of multiplexors that switches between an automorphism execution and a Fast Fourier Transform execution.

6. The computer-implemented method of claim 1, wherein the butterfly network of a Homomorphic Encryption system is adapted to execute Cheon-Kim-Kim-Song automorphism operation of a rotation on a polynomial of N elements using N/2 processing cells of the butterfly network.

7. The computer-implemented method of claim 1, wherein the butterfly network is a Gentleman-Sande Network adapted with the set of processing cells, each processing cell comprising a switch that switches between an automorphism execution and a Fast Fourier Transform execution.

8. A computer program product comprising one or more computer readable storage media, and program instructions collectively stored on the one or more computer readable storage media, the program instructions executable by a processor to cause the processor to perform operations comprising:
constructing a Homomorphic Encryption system comprising a set of processing cells configured in a butterfly network;
generating, by executing a specially purposed configuration instruction within a configuration component of the Homomorphic Encryption system, a switch rule for each processing cell of the set of processing cells; and
executing the switch rule by a processing component of the Homomorphic Encryption system on the set of processing cells wherein the Homomorphic Encryption system computes an automorphism operation by traversing the butterfly network according to a number of input elements of the automorphism operation.

9. The computer program product of claim 8, wherein executing the configuration instruction comprising a polynomial modulus a degree and a rotation amount outputs the switch rule comprising a set of configuration bits for each processing cell in the butterfly network.

10. The computer program product of claim 8, wherein a number of stages of the butterfly network of the Homomorphic Encryption system is determined based on a coefficient index modulus a number of input elements of the polynomial.

11. The computer program product of claim 8, wherein the set of processing cells is grouped into stages wherein executing the switch rule computes the automorphism operation of a rotation on a polynomial of N elements using less than log N stages of the butterfly network.

12. The computer program product of claim 8, wherein each processing cell of the set of processing cells comprises at least a set of multiplexors that switches between an automorphism execution and a Fast Fourier Transform execution.

13. The computer program product of claim 8, wherein the butterfly network of a Homomorphic Encryption system is adapted to execute Cheon-Kim-Kim-Song automorphism operation of a rotation on a polynomial of N elements using N/2 processing cells of the butterfly network.

14. The computer program product of claim 8, wherein the butterfly network is a Gentleman-Sande Network adapted with the set of processing cells, each processing cell comprising a switch that switches between an automorphism execution and a Fast Fourier Transform execution.

15. A computer system comprising a processor and one or more computer readable storage media, and program instructions collectively stored on the one or more computer readable storage media, the program instructions executable by the processor to cause the processor to perform operations comprising:
constructing a Homomorphic Encryption system comprising a set of processing cells configured in a butterfly network;
generating, by executing a specially purposed configuration instruction within a configuration component of the Homomorphic Encryption system, a switch rule for each processing cell of the set of processing cells; and
executing the switch rule by a processing component of the Homomorphic Encryption system on the set of processing cells wherein the Homomorphic Encryption system computes an automorphism operation by traversing the butterfly network according to a number of input elements of the automorphism operation.

16. The computer system of claim 15, wherein executing the configuration instruction comprising a polynomial modulus a degree and a rotation amount outputs the switch rule comprising a set of configuration bits for each processing cell in the butterfly network.

17. The computer system of claim 15, wherein a number of stages of the butterfly network of the Homomorphic Encryption system is determined based on a coefficient index modulus a number of input elements of the polynomial.

18. The computer system of claim 15, wherein the set of processing cells is grouped into stages wherein executing the switch rule computes the automorphism operation of a rotation on a polynomial of N elements using less than log N stages of the butterfly network.

19. The computer system of claim 15, wherein each processing cell of the set of processing cells comprises at least a set of multiplexors that switches between an automorphism execution and a Fast Fourier Transform execution.

20. The computer system of claim 15, wherein the butterfly network of a Homomorphic Encryption system is adapted to execute Cheon-Kim-Kim-Song automorphism operation of a rotation on a polynomial of N elements using N/2 processing cells of the butterfly network.
